(19) United States
(12) Patent Application Publication
(10) Pub. No.: US 2025/0238480 A1
(43) Pub. Date: Jul. 24, 2025

(54) Method, System, and Computer Program Product for Unsupervised Alignment of Embedding Spaces

(71) Applicant: Visa International Service Association, San Francisco, CA (US)

(72) Inventors: Yan Zheng, Los Gatos, CA (US); Prince Osei Aboagye, Salt Lake City, UT (US); Zhongfang Zhuang, San Jose, CA (US); Michael Yeh, Newark, CA (US); Junpeng Wang, Santa Clara, CA (US); Liang Wang, San Jose, CA (US); Javid Ebrahimi, Redwood City, CA (US); Wei Zhang, Fremont, CA (US)

(21) Appl. No.: 18/698,214

(22) PCT Filed: Sep. 30, 2022
(86) PCT No.: PCT/US2022/045292

§ 371 Date: Apr. 3, 2024

Related U.S. Application Data
(60) Provisional application No. 63/251,772, filed on Oct. 4, 2021.

(51) Int. Cl. G06F 17/16; G06F 17/11

(52) U.S. Cl. CPC G06F 17/16; G06F 17/11

(57) ABSTRACT

Provided are methods, systems, and computer program products for unsupervised alignment of embedding spaces. A method may include receiving a first embedding matrix and a second embedding matrix. The first embedding matrix may include a plurality of source points and the second embedding matrix may include a plurality of target points. An initial permutation matrix and an initial orthogonal matrix may be initialized. A permutation matrix may be determined based on the initial permutation matrix, the first embedding matrix, and the second embedding matrix. An orthogonal matrix may be determined based on the initial orthogonal matrix, the first embedding matrix, the permutation matrix, and the second embedding matrix. For each step of a target number of steps, the following may be repeated: updating the permutation matrix based on a quantized 2-Wasserstein distance, and updating the orthogonal matrix based on a gradient descent and a Procrustes problem.

### CROSS-REFERENCE TO RELATED APPLICATIONS

This application is the United States national phase of International Application No. PCT/US2022/045292 filed Sep. 30, 2022, and claims priority to U.S. Provisional Patent Application No. 63/251,772 filed on Oct. 4, 2021, the disclosures of which are incorporated by reference herein in their entireties.

### BACKGROUND

### 1. Technical Field

This disclosure relates generally to methods, systems, and products for alignment of embedding spaces and, in non-limiting embodiments or aspects, systems, methods, and computer program products for unsupervised (e.g., quantized Wasserstein Procrustes) alignment of embedding spaces.

### 2. Technical Considerations

Alignment of higher-dimensional sets of point clouds or embeddings spans many applications. For example, such techniques have been applied for natural language processing (e.g., cross-lingual word embeddings (CLWEs), bilingual lexicon induction (BLI), sentence translation, and cross-lingual information retrieval), computer vision (e.g., image registration), and biology (e.g., single-cell alignment and genomic and proteomic sequence alignment).

However, certain techniques for aligning embeddings (e.g., Optimal Transport (OT) methods, linear programming algorithms, and approximate solvers via Sinkhorn) have a high computational cost. For example, such techniques may scale quadratically and/or cubically with respect to the size of the input (e.g., size of an input matrix). Such high computational costs may make it impractical and/or infeasible to use such techniques for large sample sizes.

For example, in natural language processing, aligning monolingual embedding spaces to share a cross-lingual vector space has been shown to improve tasks such as BLI, machine translation, and cross-lingual information retrieval. As such, alignment of monolingual embedding spaces may facilitate cross-lingual transfer of language technologies from high-resource languages to low-resource languages. However, aligning such large datasets requires large sample sizes, resulting in a higher computational cost. As such, the computational cost for the aforementioned alignment techniques may be so high that the sample size may need to be restricted, and such restriction may result in an ineffective approximation for alignment between embedding spaces.

### SUMMARY

Accordingly, provided are improved methods, systems, and computer program products for unsupervised alignment of embedding spaces.

According to non-limiting embodiments or aspects, provided is a computer-implemented method including receiving a first embedding matrix and a second embedding matrix, the first embedding matrix including a plurality of source points and the second embedding matrix including a plurality of target points. The method may further include initializing an initial permutation matrix and an initial orthogonal matrix. The method may further include determining a permutation matrix based on the initial permutation matrix, the first embedding matrix, and the second embedding matrix. The method may further include determining an orthogonal matrix based on the initial orthogonal matrix, the first embedding matrix, the permutation matrix, and the second embedding matrix. For each step of a target number of steps, the method may further include updating the permutation matrix based on a quantized 2-Wasserstein distance and updating the orthogonal matrix based on a gradient descent and a Procrustes problem.

In some non-limiting embodiments or aspects, determining the permutation matrix may include determining the permutation matrix based on a Frank-Wolfe algorithm.

In some non-limiting embodiments or aspects, determining the orthogonal matrix may include determining the orthogonal matrix based on a Procrustes problem.

In some non-limiting embodiments or aspects, the target number of steps may include a target number of iterations for each epoch of a target number of epochs.

In some non-limiting embodiments or aspects, updating the permutation matrix may include sampling a first subset of the plurality of source points and sampling a second subset of the plurality of target points. In some non-limiting embodiments or aspects, updating the permutation matrix may further include clustering the first subset into a set of first clusters and clustering the second subset into a set of second clusters. In some non-limiting embodiments or aspects, updating the permutation matrix may further include determining a respective first anchor point for each first cluster of the set of first clusters and determining a respective second anchor point for each second cluster of the set of second clusters. In some non-limiting embodiments or aspects, updating the permutation matrix may further include determining a set of first weight values based on each respective source point of each respective first cluster and the respective first anchor point and determining a set of second weight values based on each respective target point of each respective second cluster and the respective second anchor point. In some non-limiting embodiments or aspects, updating the permutation matrix may further include updating the permutation matrix based on the set of first weight values and the set of second weight values.

In some non-limiting embodiments or aspects, updating the permutation matrix may further include determining a cost matrix based on the respective first anchor point of each first cluster and the respective second anchor point of each second cluster. In some non-limiting embodiments or aspects, updating the permutation matrix based on the set of first weight values and the set of second weight values may include updating the permutation matrix based on the set of first weight values, the set of second weight values, and the cost matrix.

In some non-limiting embodiments or aspects, updating the permutation matrix based on the set of first weight values and the set of second weight values may include determining a weighted Wasserstein distance based on the set of first weight values and the set of second weight values. In some non-limiting embodiments or aspects, updating the permutation matrix based on the set of first weight values and the set of second weight values may further include updating the permutation matrix based on the weighted Wasserstein distance.

In some non-limiting embodiments or aspects, determining the weighted Wasserstein distance may include determining the weighted Wasserstein distance based on a Sinkhorn approximate solver.

In some non-limiting embodiments or aspects, a number of source points in the first subset of the plurality of source points may be greater than a first number of clusters in the set of first clusters and a number of target points in the second subset of the plurality of target points may be greater than a second number of clusters in the set of second clusters.

In some non-limiting embodiments or aspects, the number of source points in the first subset of the plurality of source points may be equal to a target number of anchor points squared multiplied by a logarithm of the target number of anchor points and the number of target points in the second subset of the plurality of target points may be equal to the target number of anchor points squared multiplied by a logarithm of the target number of anchor points.

In some non-limiting embodiments or aspects, the respective first anchor point for each respective first cluster of the set of first clusters may be a respective center point of the respective first cluster of the set of first clusters.

In some non-limiting embodiments or aspects, the respective second anchor point for each respective second cluster of the set of second clusters may be a respective center point of the respective second cluster of the set of second clusters.

In some non-limiting embodiments or aspects, clustering the first subset into the set of first clusters may include clustering the first subset into the set of first clusters based on a k-means clustering algorithm and clustering the second subset into the set of second clusters may include clustering the second subset into the set of second clusters based on the k-means clustering algorithm.

In some non-limiting embodiments or aspects, clustering the first subset into the set of first clusters may include clustering the first subset into the set of first clusters based on a k-means++ clustering algorithm and clustering the second subset into the set of second clusters may include clustering the second subset into the set of second clusters based on the k-means++ clustering algorithm.

According to non-limiting embodiments or aspects, provided is a system including at least one processor programmed or configured to receive a first embedding matrix and a second embedding matrix. The first embedding matrix may include a plurality of source points and the second embedding matrix may include a plurality of target points. The system may be further programmed or configured to initialize an initial permutation matrix and an initial orthogonal matrix. The system may be further programmed or configured to determine a permutation matrix based on the initial permutation matrix, the first embedding matrix, and the second embedding matrix. The system may be further programmed or configured to determine an orthogonal matrix based on the initial orthogonal matrix, the first embedding matrix, the permutation matrix, and the second embedding matrix. For each step of a target number of steps, the system may be further programmed or configured to update the permutation matrix based on a quantized 2-Wasserstein distance and update the orthogonal matrix based on a gradient descent and a Procrustes problem.

According to non-limiting embodiments or aspects, provided is a computer program product including at least one non-transitory computer-readable medium including one or more instructions that, when executed by at least one processor, cause the at least one processor to receive a first embedding matrix and a second embedding matrix. The first embedding matrix may include a plurality of source points and the second embedding matrix may include a plurality of target points. The one or more instructions may further cause the at least one processor to initialize an initial permutation matrix and an initial orthogonal matrix. The one or more instructions may further cause the at least one processor to determine a permutation matrix based on the initial permutation matrix, the first embedding matrix, and the second embedding matrix. The one or more instructions may further cause the at least one processor to determine an orthogonal matrix based on the initial orthogonal matrix, the first embedding matrix, the permutation matrix, and the second embedding matrix. For each step of a target number of steps, the one or more instructions may further cause the at least one processor to update the permutation matrix based on a quantized 2-Wasserstein distance and update the orthogonal matrix based on a gradient descent and a Procrustes problem.

Further non-limiting embodiments or aspects are set forth in the following numbered clauses:

Clause 1: A computer-implemented method, comprising: receiving, with at least one processor, a first embedding matrix and a second embedding matrix, wherein the first embedding matrix comprises a plurality of source points and the second embedding matrix comprises a plurality of target points; initializing, with the at least one processor, an initial permutation matrix and an initial orthogonal matrix; determining, with the at least one processor, a permutation matrix based on the initial permutation matrix, the first embedding matrix, and the second embedding matrix; determining, with the at least one processor, an orthogonal matrix based on the initial orthogonal matrix, the first embedding matrix, the permutation matrix, and the second embedding matrix; and for each step of a target number of steps: updating, with the at least one processor, the permutation matrix based on a quantized 2-Wasserstein distance; and updating, with the at least one processor, the orthogonal matrix based on a gradient descent and a Procrustes problem.

Clause 2: The method of clause 1, wherein determining the permutation matrix comprises determining the permutation matrix based on a Frank-Wolfe algorithm.

Clause 3: The method of clauses 1 or 2, wherein determining the orthogonal matrix comprises determining the orthogonal matrix based on a Procrustes problem.

Clause 4: The method of any of clauses 1-3, wherein the target number of steps comprises a target number of iterations for each epoch of a target number of epochs.

Clause 5: The method of any of clauses 1-4, wherein updating the permutation matrix comprises: sampling a first subset of the plurality of source points; sampling a second subset of the plurality of target points; clustering the first subset into a set of first clusters; clustering the second subset into a set of second clusters; determining a respective first anchor point for each first cluster of the set of first clusters; determining a respective second anchor point for each second cluster of the set of second clusters; determining a set of first weight values based on each respective source point of each respective first cluster and the respective first anchor point; determining a set of second weight values based on each respective target point of each respective second cluster and the respective second anchor point; and updating the permutation matrix based on the set of first weight values and the set of second weight values.

Clause 6: The method of any of clauses 1-5, wherein updating the permutation matrix further comprises: determining a cost matrix based on the respective first anchor point of each first cluster and the respective second anchor point of each second cluster, wherein updating the permutation matrix based on the set of first weight values and the set of second weight values comprises updating the permutation matrix based on the set of first weight values, the set of second weight values, and the cost matrix.

Clause 7: The method of any of clauses 1-6, wherein updating the permutation matrix based on the set of first weight values and the set of second weight values comprises: determining a weighted Wasserstein distance based on the set of first weight values and the set of second weight values; and updating the permutation matrix based on the weighted Wasserstein distance.

Clause 8: The method of any of clauses 1-7, wherein determining the weighted Wasserstein distance comprises determining the weighted Wasserstein distance based on a Sinkhorn approximate solver.

Clause 9: The method of any of clauses 1-8, wherein a number of source points in the first subset of the plurality of source points is greater than a first number of clusters in the set of first clusters, and wherein a number of target points in the second subset of the plurality of target points is greater than a second number of clusters in the set of second clusters.

Clause 10: The method of any of clauses 1-9, wherein: the number of source points in the first subset of the plurality of source points is equal to a target number of anchor points squared multiplied by a logarithm of the target number of anchor points, and the number of target points in the second subset of the plurality of target points is equal to the target number of anchor points squared multiplied by a logarithm of the target number of anchor points.

Clause 11: The method of any of clauses 1-10, wherein the respective first anchor point for each respective first cluster of the set of first clusters is a respective center point of the respective first cluster of the set of first clusters.

Clause 12: The method of any of clauses 1-11, wherein the respective second anchor point for each respective second cluster of the set of second clusters is a respective center point of the respective second cluster of the set of second clusters.

Clause 13: The method of any of clauses 1-12, wherein clustering the first subset into the set of first clusters comprises clustering, with at least one processor, the first subset into the set of first clusters based on a k-means clustering algorithm, and wherein clustering the second subset into the set of second clusters comprises clustering, with at least one processor, the second subset into the set of second clusters based on the k-means clustering algorithm.

Clause 14: The method of any of clauses 1-13, wherein clustering the first subset into the set of first clusters comprises clustering the first subset into the set of first clusters based on a k-means++ clustering algorithm, and wherein clustering the second subset into the set of second clusters comprises clustering, with at least one processor, the second subset into the set of second clusters based on the k-means++ clustering algorithm.

Clause 15: A system comprising at least one processor programmed or configured to: receive a first embedding matrix and a second embedding matrix, wherein the first embedding matrix comprises a plurality of source points and the second embedding matrix comprises a plurality of target points; initialize an initial permutation matrix and an initial orthogonal matrix; determine a permutation matrix based on the initial permutation matrix, the first embedding matrix, and the second embedding matrix; determine an orthogonal matrix based on the initial orthogonal matrix, the first embedding matrix, the permutation matrix, and the second embedding matrix; and for each step of a target number of steps, the at least one processor is programmed or configured to: update the permutation matrix based on a quantized 2-Wasserstein distance; and update the orthogonal matrix based on a gradient descent and a Procrustes problem.

Clause 16: The system of clause 15, wherein, when determining the permutation matrix, the at least one processor is programmed or configured to determine the permutation matrix based on a Frank-Wolfe algorithm.

Clause 17: The system of clauses 15 or 16, wherein, when determining the orthogonal matrix, the at least one processor is programmed or configured to determine the orthogonal matrix based on a Procrustes problem.

Clause 18: The system of any of clauses 15-17, wherein the target number of steps comprises a target number of iterations for each epoch of a target number of epochs.

Clause 19: The system of any of clauses 15-18, wherein, when updating the permutation matrix, the at least one processor is programmed or configured to: sample a first subset of the plurality of source points; sample a second subset of the plurality of target points; cluster the first subset into a set of first clusters; cluster the second subset into a set of second clusters; determine a respective first anchor point for each first cluster of the set of first clusters; determine a respective second anchor point for each second cluster of the set of second clusters; determine a set of first weight values based on each respective source point of each respective first cluster and the respective first anchor point; determine a set of second weight values based on each respective target point of each respective second cluster and the respective second anchor point; and update the permutation matrix based on the set of first weight values and the set of second weight values.

Clause 20: The system of any of clauses 15-19, wherein, when updating the permutation matrix, the at least one processor is further programmed or configured to: determine a cost matrix based on the respective first anchor point of each first cluster and the respective second anchor point of each second cluster, wherein, when updating the permutation matrix based on the set of first weight values and the set of second weight values, the at least one processor is programmed or configured to update the permutation matrix based on the set of first weight values, the set of second weight values, and the cost matrix.

Clause 21: The system of any of clauses 15-20, wherein, when updating the permutation matrix based on the set of first weight values and the set of second weight values, the at least one processor is programmed or configured to: determine a weighted Wasserstein distance based on the set of first weight values and the set of second weight values; and update the permutation matrix based on the weighted Wasserstein distance.

Clause 22: The system of any of clauses 15-21, wherein, when determining the weighted Wasserstein distance, the at least one processor is programmed or configured to determine the weighted Wasserstein distance based on a Sinkhorn approximate solver.

Clause 23: The system of any of clauses 15-22, wherein a number of source points in the first subset of the plurality of source points is greater than a first number of clusters in the set of first clusters, and wherein a number of target points in the second subset of the plurality of target points is greater than a second number of clusters in the set of second clusters.

Clause 24: The system of any of clauses 15-23, wherein: the number of source points in the first subset of the plurality of source points is equal to a target number of anchor points squared multiplied by a logarithm of the target number of anchor points, and the number of target points in the second subset of the plurality of target points is equal to the target number of anchor points squared multiplied by a logarithm of the target number of anchor points.

Clause 25: The system of any of clauses 15-24, wherein the respective first anchor point for each respective first cluster of the set of first clusters is a respective center point of the respective first cluster of the set of first clusters.

Clause 26: The system of any of clauses 15-25, wherein the respective second anchor point for each respective second cluster of the set of second clusters is a respective center point of the respective second cluster of the set of second clusters.

Clause 27: The system of any of clauses 15-26, wherein, when clustering the first subset into the set of first clusters, the at least one processor is programmed or configured to cluster the first subset into the set of first clusters based on a k-means clustering algorithm, and wherein, when clustering the second subset into the set of second clusters, the at least one processor is programmed or configured to cluster the second subset into the set of second clusters based on the k-means clustering algorithm.

Clause 28: The system of any of clauses 15-27, wherein, when clustering the first subset into the set of first clusters, the at least one processor is programmed or configured to cluster the first subset into the set of first clusters based on a k-means++ clustering algorithm, and wherein, when clustering the second subset into the set of second clusters, the at least one processor is programmed or configured to cluster the second subset into the set of second clusters based on the k-means++ clustering algorithm.

Clause 29: A computer program product comprising at least one non-transitory computer-readable medium including one or more instructions that, when executed by at least one processor, cause the at least one processor to: receive a first embedding matrix and a second embedding matrix, wherein the first embedding matrix comprises a plurality of source points and the second embedding matrix comprises a plurality of target points; initialize an initial permutation matrix and an initial orthogonal matrix; determine a permutation matrix based on the initial permutation matrix, the first embedding matrix, and the second embedding matrix; determine an orthogonal matrix based on the initial orthogonal matrix, the first embedding matrix, the permutation matrix, and the second embedding matrix; and for each step of a target number of steps, the one or more instructions cause the at least one processor to: update the permutation matrix based on a quantized 2-Wasserstein distance; and update the orthogonal matrix based on a gradient descent and a Procrustes problem.

Clause 30: The computer program product of clause 29, wherein the one or more instructions that cause the at least one processor to determine the permutation matrix cause the at least one processor to determine the permutation matrix based on a Frank-Wolfe algorithm.

Clause 31: The computer program product of clauses 29 or 30, wherein the one or more instructions that cause the at least one processor to determine the orthogonal matrix cause the at least one processor to determine the orthogonal matrix based on a Procrustes problem.

Clause 32: The computer program product of any of clauses 29-31, wherein the target number of steps comprises a target number of iterations for each epoch of a target number of epochs.

Clause 33: The computer program product of any of clauses 29-32, wherein the one or more instructions that cause the at least one processor to update the permutation matrix cause the at least one processor to: sample a first subset of the plurality of source points; sample a second subset of the plurality of target points; cluster the first subset into a set of first clusters; cluster the second subset into a set of second clusters; determine a respective first anchor point for each first cluster of the set of first clusters; determine a respective second anchor point for each second cluster of the set of second clusters; determine a set of first weight values based on each respective source point of each respective first cluster and the respective first anchor point; determine a set of second weight values based on each respective target point of each respective second cluster and the respective second anchor point; and update the permutation matrix based on the set of first weight values and the set of second weight values.

Clause 34: The computer program product of any of clauses 29-33, wherein the one or more instructions that cause the at least one processor to update the permutation matrix further cause the at least one processor to: determine a cost matrix based on the respective first anchor point of each first cluster and the respective second anchor point of each second cluster, wherein the one or more instructions that cause the at least one processor to update the permutation matrix based on the set of first weight values and the set of second weight values cause the at least one processor to update the permutation matrix based on the set of first weight values, the set of second weight values, and the cost matrix.

Clause 35: The computer program product of any of clauses 29-34, wherein the one or more instructions that cause the at least one processor to update the permutation matrix based on the set of first weight values and the set of second weight values cause the at least one processor to: determine a weighted Wasserstein distance based on the set of first weight values and the set of second weight values; and update the permutation matrix based on the weighted Wasserstein distance.

Clause 36: The computer program product of any of clauses 29-35, wherein the one or more instructions that cause the at least one processor to determine the weighted Wasserstein distance cause the at least one processor to determine the weighted Wasserstein distance based on a Sinkhorn approximate solver.

Clause 37: The computer program product of any of clauses 29-36, wherein a number of source points in the first subset of the plurality of source points is greater than a first number of clusters in the set of first clusters, and wherein a number of target points in the second subset of the plurality of target points is greater than a second number of clusters in the set of second clusters.

Clause 38: The computer program product of any of clauses 29-37, wherein: the number of source points in the first subset of the plurality of source points is equal to a target number of anchor points squared multiplied by a logarithm of the target number of anchor points, and the number of target points in the second subset of the plurality of target points is equal to the target number of anchor points squared multiplied by a logarithm of the target number of anchor points.

Clause 39: The computer program product of any of clauses 29-38, wherein the respective first anchor point for each respective first cluster of the set of first clusters is a respective center point of the respective first cluster of the set of first clusters.

Clause 40: The computer program product of any of clauses 29-39, wherein the respective second anchor point for each respective second cluster of the set of second clusters is a respective center point of the respective second cluster of the set of second clusters.

Clause 41: The computer program product of any of clauses 29-40, wherein the one or more instructions that cause the at least one processor to cluster the first subset into the set of first clusters cause the at least one processor to cluster the first subset into the set of first clusters based on a k-means clustering algorithm, and wherein the one or more instructions that cause the at least one processor to cluster the second subset into the set of second clusters cause the at least one processor to cluster the second subset into the set of second clusters based on the k-means clustering algorithm.

Clause 42: The computer program product of any of clauses 29-41, wherein the one or more instructions that cause the at least one processor to cluster the first subset into the set of first clusters cause the at least one processor to cluster the first subset into the set of first clusters based on a k-means++ clustering algorithm, and wherein the one or more instructions that cause the at least one processor to cluster the second subset into the set of second clusters cause the at least one processor to cluster the second subset into the set of second clusters based on the k-means++ clustering algorithm.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a non-limiting embodiment or aspect of a system for unsupervised alignment of embedding spaces according to the principles of the presently disclosed subject matter;

FIG. 2 is a flow diagram of a non-limiting embodiment or aspect of a process for unsupervised alignment of embedding spaces according to the principles of the presently disclosed subject matter;

FIG. 3 is a diagram of a non-limiting embodiment or aspect of an environment in which methods, systems, and/or computer program products, described herein, may be implemented according to the principles of the presently disclosed subject matter;

FIG. 4 is a diagram of a non-limiting embodiment or aspect of components of one or more devices of FIG. 1 and/or FIG. 3; and

FIG. 5 is a diagram of a non-limiting embodiment or aspect of an exemplary output generated by a processor for unsupervised alignment of embedding spaces according to the principles of the presently disclosed subject matter.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting unless otherwise indicated.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server and/or computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server and/or computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, radio frequency identification (RFID) receivers, and/or other contactless transceivers or receivers, contact-based receivers, payment terminals, computers, servers, input devices, and/or other like devices that can be used to initiate a payment transaction.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

The term “processor,” as used herein, may represent any type of processing unit, such as a single processor having one or more cores, one or more cores of one or more processors, multiple processors each having one or more cores, and/or other arrangements and combinations of processing units.

Non-limiting embodiments or aspects of the disclosed subject matter are directed to systems, methods, and computer program products for alignment of embedding spaces, including, but not limited to, unsupervised alignment of embedding spaces. For example, non-limiting embodiments or aspects of the disclosed subject matter provide for iteratively updating a permutation matrix based on a quantized 2-Wasserstein distance problem and an orthogonal matrix based on a gradient descent and a Procrustes problem. Non-limiting embodiments or aspects may determine initial permutation matrices and initial orthogonal matrices based on a set of source points in one embedding space (e.g., a first embedding space) and a set of target points in another embedding space (e.g., a second embedding space). The permutation matrix and the orthogonal matrix may describe (e.g., may represent) the alignment of the embedding spaces. Non-limiting embodiments or aspects may provide techniques and systems that provide improved calculation of the embedding spaces and/or the alignment of the embedding spaces with an estimation algorithm (e.g., 2-Wasserstein distance and gradient descent), compared to other approaches of approximating an alignment of embedding spaces (e.g., Optimal Transport). Additionally, such non-limiting embodiments or aspects may provide for reduced computational cost of the system and/or processor when determining the alignment of embedding spaces. Non-limiting embodiments or aspects may provide for improved accuracy compared to other techniques where larger sample sizes (e.g., larger embedding matrices) are provided as input.

For the purpose of illustration, in the following description, while the presently disclosed subject matter is described with respect to methods, systems, and computer program products for unsupervised alignment of embedding spaces, e.g., for use in natural language processing (NLP), one skilled in the art will recognize that the disclosed subject matter is not limited to the illustrative embodiments or aspects. For example, the methods, systems, and computer program products described herein may be used with a wide variety of settings, such as unsupervised alignment of embedding spaces in any setting suitable for using alignment of embedding spaces, e.g., computer vision, genomic and proteomic sequence alignment, sentence translation, or embedding alignment in other contexts (e.g., alignment of merchant embeddings, product recommendation, international business development, and/or the like), and/or the like.

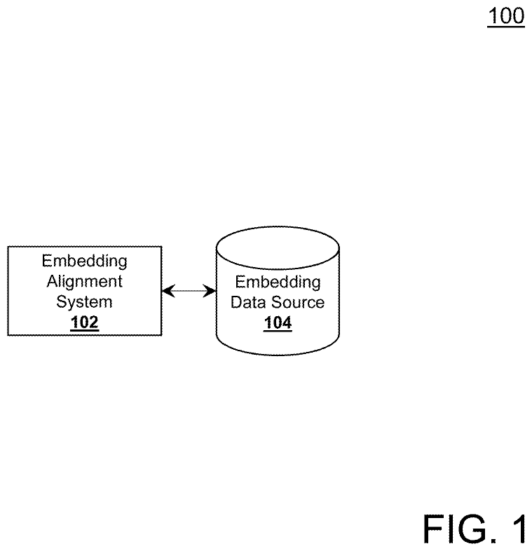

Referring now to FIG. 1, FIG. 1 depicts an exemplary system 100 for unsupervised alignment of embedding spaces. As shown in FIG. 1, system 100 may include embedding alignment system 102 and embedding data source 104.

Embedding alignment system 102 may include one or more devices capable of receiving information from and/or communicating information to embedding data source 104. For example, embedding alignment system 102 may include a computing device, such as a computer, a server, a group of servers, and/or other like devices. In some non-limiting embodiments or aspects, embedding alignment system 102 may include at least one graphics processing unit (GPU), at least one central processing unit (CPU), and/or the like having highly parallel structure and/or multiple cores to enable more efficient and/or faster performance of calculating and/or aligning one or more embedding spaces. For example, embedding alignment system 102 may include one or more (e.g., a plurality of) GPUs.

In some non-limiting embodiments or aspects, embedding alignment system 102 may include one or more software instructions (e.g., one or more software applications) executing on a server (e.g., a single server), a group of servers, a computing device (e.g., a single computing device), a group of computing devices, and/or other like devices. In some non-limiting embodiments or aspects, embedding alignment system 102 may be configured to communicate with embedding data source 104. In some non-limiting embodiments or aspects, embedding alignment system 102 may be in communication with embedding data source 104 such that embedding alignment system 102 is separate from embedding data source 104. In some non-limiting embodiments or aspects, embedding data source 104 may be implemented by (e.g., may be part of) embedding alignment system 102.

Embedding data source 104 may include one or more devices capable of receiving information from and/or communicating information to embedding alignment system 102. For example, embedding data source 104 may include a computing device (e.g., a database device), such as a computer, a server, a group of servers, and/or other like devices. In some non-limiting embodiments or aspects, embedding data source 104 may be in communication with a data storage device, which may be local or remote to embedding data source 104. In some non-limiting embodiments or aspects, embedding data source 104 may be capable of receiving information from, storing information in, communicating information to, or searching information stored in the data storage device.

In some non-limiting embodiments or aspects, embedding data source 104 may be associated with one or more computing devices providing interfaces, such that a user (e.g., an administrative user) may interact with embedding data source 104 via the one or more computing devices. Embedding data source 104 may be in communication with embedding alignment system 102 such that embedding data source 104 is separate from embedding alignment system 102. Alternatively, in some non-limiting embodiments or aspects, embedding data source 104 may be implemented by (e.g., may be part of) embedding alignment system 102.

The number and arrangement of systems and/or devices shown in FIG. 1 are provided as an example. There may be additional systems and/or devices; fewer systems and/or devices; different systems and/or devices; and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

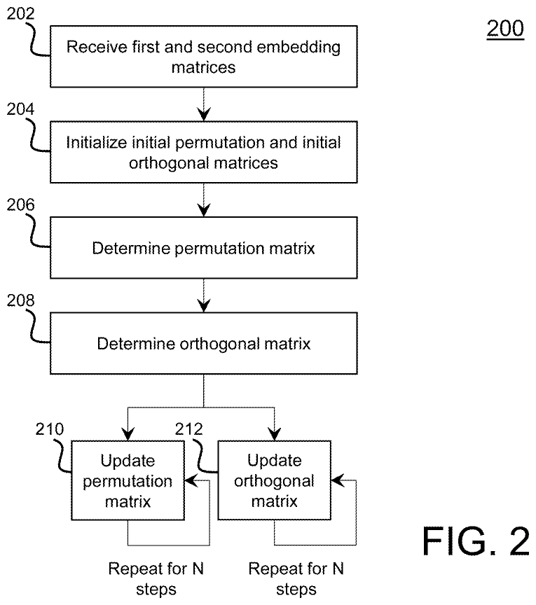

Referring now to FIG. 2, FIG. 2 is a flowchart of an exemplary process 200 for unsupervised alignment of embedding spaces. In some non-limiting embodiments or aspects, one or more of the steps of process 200 may be performed (e.g., completely, partially, and/or the like) by embedding alignment system 102 (e.g., one or more devices of embedding alignment system 102). In some non-limiting embodiments or aspects, one or more of the steps of process 200 may be performed (e.g., completely, partially, and/or the like) by another system, another device, another group of systems, or another group of devices, separate from or including embedding alignment system 102, such as embedding data source 104.

As shown in FIG. 2, at step 202, process 200 may include receiving a first embedding matrix and a second embedding matrix. For example, embedding alignment system 102 may receive a first embedding matrix and a second embedding matrix. In some non-limiting embodiments or aspects, embedding alignment system 102 may receive the first embedding matrix and the second embedding matrix from embedding data source 104. In some non-limiting embodiments or aspects, the first embedding matrix may include a plurality of source points. Additionally or alternatively, the second embedding matrix may include a plurality of target points. In some non-limiting embodiments or aspects, the plurality of source points may be included in a first embedding space and the plurality of target points may be included in a second embedding space. An embedding space may refer to a first space (e.g., a 2-dimensional Cartesian coordinate system), where the first space has a lower dimension than a dimension of a second space (e.g., a 3-dimensional Cartesian coordinate system).

In some non-limiting embodiments or aspects, the first space may include data that is embedded (e.g., data that is represented in a dimension that is lower than a dimension of the data in its original form, such as raw data). For example, the first space (e.g., a first embedding space) may include a vector space including a plurality of vectors, where the plurality of vectors may represent a set of data (e.g., a set of raw data). In some non-limiting embodiments or aspects, the second space may include data that is in an original form (e.g., raw data, data that is not embedded, and/or the like). Alternatively, the second space (e.g., a second embedding space) may include data that is embedded (e.g., data that is an original form in a third space, where the third space has a dimension that is higher than the second space).

In some non-limiting embodiments or aspects, the first embedding space may include a first plurality of embeddings (e.g., a set of embeddings representing raw data). In some non-limiting embodiments or aspects, the first plurality of embeddings may include a first plurality of vectors, where the first plurality of vectors may represent a first set of raw data (e.g., a first set of words, such as words from the English language). The first embedding space may include the set of source points (e.g., the plurality of source points) and the set of source points may include the first plurality of vectors. For example, each source point of the set of source points may include a vector of the first plurality of vectors.

In some non-limiting embodiments or aspects, the second embedding space may include a second plurality of embeddings. In some non-limiting embodiments or aspects, the second plurality of embeddings may include a second plurality of vectors, where the second plurality of vectors may represent a second set of raw data (e.g., a second set of words, such as words from the Italian language). The second embedding space may include the set of target points and the set of target points may include the second plurality of vectors. For example, each target point of the set of target points may include a vector of the second plurality of vectors.

As shown in FIG. 2, at step 204, process 200 may include initializing an initial permutation matrix and an initial orthogonal matrix. For example, embedding alignment system 102 may initialize an initial permutation matrix and/or an initial orthogonal matrix randomly. In some non-limiting embodiments or aspects, embedding alignment system 102 may initialize the initial permutation matrix by generating the initial permutation matrix including a plurality of integers, where a first portion of the plurality of integers is equal to zero and a second portion of the plurality of integers is equal to one.

A permutation matrix may refer to a matrix that may include (e.g., represent) a one-to-one mapping (e.g., one-to-one correspondence) between each source point of the subset of source points to each target point of the set of target points. In some non-limiting embodiments or aspects, a permutation matrix (e.g., the initial permutation matrix) may include a plurality of integers. For example, a permutation matrix may include a plurality of integers equal to zero (0) and a plurality of integers equal to one (1). In some non-limiting embodiments or aspects, a permutation matrix may include exactly one integer equal to one in each row of the permutation matrix and exactly one integer equal to one in each column of the permutation matrix. The permutation matrix may include a plurality of integers equal to zero in all other columns and all other rows that do not include the exactly one integer equal to one in each row and the exactly one integer equal to one in each column of the permutation matrix.

An orthogonal matrix may refer to a first matrix which is associated with an inverse matrix (e.g., an inverse matrix of the first matrix), where the inverse matrix is equivalent to a transpose matrix that is associated with the first matrix (e.g., a transpose matrix of the first matrix). In some non-limiting embodiments or aspects, an orthogonal matrix may include a square matrix (e.g., a matrix having an equal number of rows and columns). In some non-limiting embodiments or aspects, an orthogonal matrix may refer to a matrix including two or more vectors where the two or more vectors are orthogonal (e.g., two vectors are perpendicular to one another, a dot product of two vectors is equal to 0, and/or the like). For example, an orthogonal matrix may include a matrix having a first row, a second row, and a third row and may include a first column, a second column, and a third column. The first row may include [1, 0, 0], the second row may include [0, −1, 0] and the third row may include [0, 0, 1].

As shown in FIG. 2, at step 206, process 200 may include determining a permutation matrix. For example, embedding alignment system 102 may determine the permutation matrix based on the initial permutation matrix and the first and second embedding matrices. In some non-limiting embodiments or aspects, embedding alignment system 102 may determine the permutation matrix based on a Wasserstein-Procrustes problem defined by the following equation (1):

$${W}^{*} , {P}^{*} = {arg min}_{W ∈ {𝒪}_{d} , P ∈ {𝒫}_{n}} {‖ XW - PY ‖}_{F}^{2} , \qquad ( 1 )$$

where W* is an orthogonal matrix (e.g., the initial orthogonal matrix, a linear transformation, an estimate of the orthogonal matrix, and/or the like), P* is the permutation matrix, W is an orthogonal matrix (e.g., the initial orthogonal matrix), [symbol] is a set of orthogonal matrices (e.g., a plurality of orthogonal matrices), P is a permutation matrix (e.g., the initial permutation matrix), [symbol] is a set of permutation matrices (e.g., a plurality of permutation matrices), X is the first embedding matrix, Y is the second embedding matrix, and ∥⋅∥_{F} denotes a Frobenius norm.

In some non-limiting embodiments or aspects, embedding alignment system 102 may determine the permutation matrix and the orthogonal matrix jointly based on equation (1) using an unsupervised machine learning model. For example, embedding alignment system 102 may determine the permutation matrix and the orthogonal matrix by estimating the permutation matrix and the orthogonal matrix based on equation (1), where the permutation matrix and/or the orthogonal matrix are unknown variables. Embedding alignment system 102 may determine the permutation matrix and the orthogonal matrix in this way by alternating between minimizing the permutation matrix and minimizing the orthogonal matrix. As a further example, embedding alignment system 102 may first determine the orthogonal matrix when the permutation matrix is known (e.g., given) by estimating the orthogonal matrix (e.g., by using one or more pairs of corresponding translated words obtained from the source points and the target points and using equation (3) disclosed herein). Alternatively, embedding alignment system 102 may first determine the permutation matrix when the orthogonal matrix is known (e.g., given) by estimating the permutation matrix (e.g., by minimizing a 2-Wasserstein distance). In some non-limiting embodiments or aspects, embedding alignment system 102 may estimate (e.g., determine) the permutation matrix by minimizing a 2-Wasserstein distance between the first embedding matrix and the second embedding matrix defined by the following equation (2):

$${W}_{2}^{2} ( XW , Y ) = {min}_{p ∈ {𝒫}_{n}} {\sum }_{i , j = 1}^{n} {‖ {x}_{i} - {y}_{i} ‖}_{2}^{2} {P}_{ij} , \qquad ( 2 )$$

where W₂² (XW, Y) is a minimized 2-Wasserstein distance between the first embedding matrix (e.g., the source points) and the second embedding matrix (e.g., the target points), Pᵢⱼ is an updated permutation matrix (e.g., the permutation matrix), [symbol] is a set of permutation matrices (e.g., a plurality of permutation matrices), P is the permutation matrix, xᵢ is the subset of source points, and yⱼ is the set of target points.

In some non-limiting embodiments or aspects, the permutation matrix may be determined based on a Frank-Wolfe algorithm.

As shown in FIG. 2, at step 208, process 200 may include determining an orthogonal matrix. For example, embedding alignment system 102 may determine the orthogonal matrix based on the initial orthogonal matrix, the first and second embedding matrices, and the permutation matrix. In some non-limiting embodiments or aspects, the orthogonal matrix may be determined based on a matrix approximation problem (e.g., a Procrustes problem). In some non-limiting embodiments or aspects, embedding alignment system 102 may determine the orthogonal matrix based on the matrix approximation problem defined by the following equation:

$${W}^{*} = {arg min}_{W ∈ {𝒪}_{d}} {‖ XW - Y ‖}_{F}^{2} , \qquad ( 3 )$$

where W* is an updated orthogonal matrix (e.g., the orthogonal matrix), [symbol] is a set of orthogonal matrices (e.g., a plurality of orthogonal matrices), W is an original orthogonal matrix (e.g., the initial orthogonal matrix), X is the first embedding matrix, Y is the second embedding matrix, and ∥⋅∥_{F} denotes a Frobenius norm. In some non-limiting embodiments or aspects, embedding alignment system may first determine (e.g., estimate) the permutation matrix based on equation (2) disclosed herein before embedding alignment system 102 may determine the orthogonal matrix (e.g., based on equation (3) disclosed herein). Alternatively, embedding alignment system 102 may determine (e.g., estimate) the orthogonal matrix based on equation (3) disclosed herein before embedding alignment system 102 may determine the permutation matrix (e.g., based on equation (2) disclosed herein).

As shown in FIG. 2, at step 210, process 200 may include updating the permutation matrix. For example, embedding alignment system 102 may update the permutation matrix based on a quantized 2-Wasserstein distance. In some non-limiting embodiments or aspects, embedding alignment system 102 may update the permutation matrix based on the 2-Wasserstein distance defined by equation (2) disclosed herein.

In some non-limiting embodiments or aspects, a quantized 2-Wasserstein distance may refer to an alignment of two or more embedding spaces (e.g., based on a distance determined between a first anchor point (e.g., a respective first anchor point for each first cluster of the set of first clusters) and a second anchor point (e.g., a respective second anchor point for each second cluster of the set of second clusters). In some non-limiting embodiments or aspects, the quantized 2-Wasserstein distance may be based on and/or used for NLP. In some non-limiting embodiments or aspects, the two or more embedding spaces may include embeddings representing words that may correspond to two or more languages (e.g., languages used for communication, such as English, Russian, French, and/or the like) where the two or more embedding spaces may share a vector space. For example, a first word in a first embedding space (e.g., in a first language, such as English) having a first meaning may include a first vector based on the first meaning. A second word in a second embedding space (e.g., in a second language, such as Twi) also having the first meaning may include the first vector based on the first meaning. In this way, embedding alignment system 102 may determine a quantized 2-Wasserstein distance between the first word and the second word and may determine that the first word is a translation of the second word based on the first vector (e.g., the shared vector space). In some non-limiting embodiments or aspects, embedding alignment system may determine the quantized 2-Wasserstein distance using an unsupervised machine learning model.

In some non-limiting embodiments or aspects, embedding alignment system 102 may update the permutation matrix based on the quantized 2-Wasserstein distance as follows: Embedding alignment system 102 may sample a first subset of points, the first subset of points having m points (e.g., a number of points) where m=k² log k and where m>k, from the first embedding matrix (e.g., from the plurality of source points) where each point of the first subset of points may be independent and identically distributed. In some non-limiting embodiments or aspects, k may include a predetermined number of anchor points. Embedding alignment system 102 may sample a second subset of points, the second subset of points having m points (e.g., a number of points) from the second embedding matrix (e.g., from the plurality of target points) where each point of the second subset of points is independent and identically distributed. Embedding alignment system 102 may subsample a first set of anchor points equal to k anchor points (e.g., a number of anchor points) from the first subset of points. Embedding alignment system 102 may subsample a second set of anchor points equal to k anchor points from the second subset of points. Embedding alignment system 102 may generate a first cluster of points based on the first set of anchor points using k-means++ (e.g., quantization, a first quantization step, and/or the like). Embedding alignment system 102 may generate a second cluster of points based on the second set of anchor points using k-means++ (e.g., quantization, a second quantization step, and/or the like). Embedding alignment system 102 may generate a first weight based on the first set of points and the first cluster of points. Embedding alignment system 102 may generate a second weight based on the second set of points and the second cluster of points. Embedding alignment system 102 may generate a cost matrix based on the first cluster of points and the second cluster of points. In some non-limiting embodiments or aspects, embedding alignment system 102 may generate (e.g., approximate) and/or update the permutation matrix based on the cost matrix, the first weight, the second weight, and a regularization term (e.g., an entropy regularization coefficient).

In some non-limiting embodiments or aspects, embedding alignment system 102 may determine (e.g., predetermine) a value for the number of anchor points (e.g., k)

$${k}^{- \frac{1}{d}}$$

where a convergence rate of the quantized 2-Wasserstein distance is equal to where d is a dimension (e.g., an ambient dimension, such as 2-dimensional, 3-dimensional, and/or the like). In some non-limiting embodiments or aspects, embedding alignment system 102 may determine (e.g., predetermine) a value for the number of anchor points (e.g., k) where a convergence rate of the quantized 2-Wasserstein distance is equal to

$${k}^{- \frac{2}{d}} .$$

k may include an input to embedding alignment system 102 so that embedding alignment system 102 may determine the quantized 2-Wasserstein distance. In this way, the quantized 2-Wasserstein distance (e.g., the approximated distance) may require more (e.g., larger) samples of k to generate a more accurate approximation of the quantized 2-Wasserstein distance between points (e.g., embeddings) in two or more embedding matrices. In some non-limiting embodiments or aspects, embedding alignment system 102 may determine a maximum value for k based on a maximum computational cost (e.g., cost of resources for computation) of [symbol] (k³ log k) and/or embedding alignment system 102 may determine a maximum value for a regularization term e based on a maximum computational cost of [symbol] (k²ϵ⁻²).

In some non-limiting embodiments or aspects, embedding alignment system 102 may update the permutation matrix by sampling a first subset of the plurality of source points and a second subset of the plurality of target points. In some non-limiting embodiments or aspects, embedding alignment system 102 may cluster (e.g., generate one or more clusters) the first subset into a set of first clusters and embedding alignment system 102 may cluster the second subset into a set of second clusters. In some non-limiting embodiments or aspects, embedding alignment system 102 may determine a respective first anchor point for each first cluster of the set of first clusters and embedding alignment system 102 may determine a respective second anchor point for each second cluster of the set of second clusters. In some non-limiting embodiments or aspects, embedding alignment system 102 may determine a set of first weight values based on each respective source point of each respective first cluster and the respective first anchor point and embedding alignment system 102 may determine a set of second weight values based on each respective target point of each respective second cluster and the respective second anchor point. In some non-limiting embodiments or aspects, embedding alignment system 102 may update the permutation matrix based on the set of first weight values and the set of second weight values. In this way, embedding alignment system 102 may provide improved (e.g., less randomized) samples for input to a 2-Wasserstein distance calculation (e.g., the quantized 2-Wasserstein calculation) such that embedding alignment system 102 may determine an improved permutation matrix and/or set of pairs of corresponding source points and target points such that the pairs of corresponding source points and target points are paired correctly (e.g., a first word correctly corresponds to a second word such that the words are translations of each other in different languages).

In some non-limiting embodiments or aspects, embedding alignment system 102 may determine the set of first weight values based on the following equation (4):

$${a}_{i} = {\sum }_{j = 1}^{n} {1}_{i = {argmin}_{l} {‖ {x}_{j} - {c}_{l} ‖}_{2}^{2}} ∀ i ∈ \{ 1 , … , k \} , \qquad ( 4 )$$

where aᵢ is the set of first weight values, i denotes an integer representing a respective cluster of each cluster of the set of first clusters, j denotes an integer representing a source point of the set of source points (e.g., the plurality of source points of the first embedding matrix), n denotes an integer representing a total number of source points (e.g., the plurality of source points of the first embedding matrix), xⱼ is the set of source points (e.g., the plurality of source points), l denotes an integer representing the respective cluster of each cluster of the set of first clusters, where l corresponds with i, cₗ is a respective first anchor point of the set of first clusters, and k is a total number of anchor points (e.g., a total number of clusters of the first set of clusters).

In some non-limiting embodiments or aspects, embedding alignment system 102 may determine the set of second weight values based on the following equation (5):

$${b}_{i} = {\sum }_{j = 1}^{n} {1}_{i = {argmin}_{l} {‖ {x}_{j} - {d}_{l} ‖}_{2}^{2}} ∀ i ∈ \{ 1 , … , k \} , \qquad ( 5 )$$

where bᵢ is the set of second weight values, i denotes an integer representing a respective cluster of each cluster of the set of second clusters, j denotes an integer representing a source point of the set of source points (e.g., the plurality of source points of the first embedding matrix), n denotes an integer representing a total number of source points (e.g., the plurality of source points of the first embedding matrix), xⱼ is the set of source points (e.g., the plurality of source points), l denotes an integer representing the respective cluster of each cluster of the set of second clusters, where l corresponds with i, dₗ is a respective second anchor point of the set of second clusters, and k is a total number of anchor points (e.g., a total number of clusters of the set of second clusters).

In some non-limiting embodiments or aspects, embedding alignment system 102 may further update the permutation matrix by determining a cost matrix based on the respective first anchor point of each first cluster and the respective second anchor point of each second cluster. In some non-limiting embodiments or aspects, embedding alignment system 102 may update the permutation matrix based on the set of first weight values and the set of second weight values by updating the permutation matrix based on the set of first weight values, the set of second weight values, and the cost matrix.

In some non-limiting embodiments or aspects, embedding alignment system 102 may determine the cost matrix based on the following equation (6):

$${C}_{ij} = {‖ {c}_{i} - {d}_{j} ‖}_{2}^{2} ∀ i , j ∈ \{ 1 , … , n \} , \qquad ( 6 )$$

where Cᵢⱼ is the cost matrix, cᵢ is the set of first clusters, dⱼ is the set of second clusters, ∥⋅∥_{F} denotes a Frobenius norm, i denotes a row of a matrix (e.g., an integer identifier of a row of a matrix), j denotes a column of a matrix (e.g., an integer identifier of a column of a matrix), and n represents an integer equal to a total number of source points (e.g., the plurality of source points of the first embedding matrix) and a total number of target points (e.g., the plurality of target points of the second embedding matrix).

In some non-limiting embodiments or aspects, embedding alignment system 102 may update the permutation matrix based on the set of first weight values and the set of second weight values by determining a weighted Wasserstein distance based on the set of first weight values and the set of second weight values and updating the permutation matrix based on the weighted Wasserstein distance. For example, embedding alignment system 102 may update the permutation matrix (e.g., determine an updated permutation matrix) based on the cost matrix, the set of first weight values, the set of second weight values, and a regularization term (e.g., an entropy regularization coefficient).

In some non-limiting embodiments or aspects, embedding alignment system 102 may determine the weighted Wasserstein distance by determining the weighted Wasserstein distance based on a Sinkhorn approximate solver. For example, embedding alignment system 102 may update the permutation matrix (e.g., determine an updated permutation matrix) based on the cost matrix, the set of first weight values, the set of second weight values, and a regularization term (e.g., an entropy regularization coefficient) using the Sinkhorn approximate solver (e.g., a Sinkhorn algorithm). In some non-limiting embodiments or aspects, embedding alignment system 102 may determine the weighted Wasserstein distance based on a linear program solver. In some non-limiting embodiments or aspects, embedding alignment system 102 may determine the updated permutation matrix based on the Sinkhorn approximate solver defined by the following equation (7):

$${W}_{2}^{2} ( \hat{X} W , \hat{Y} ) = {min}_{P ∈ {𝒫}_{k}} {\sum }_{i , j = 1}^{k} {‖ {x}_{i} W - {y}_{j} ‖}_{2}^{2} {P}_{ij} + ϵ {\sum }_{i , j = 1}^{k} log {P}_{ij} , \qquad ( 7 )$$

where W₂²(\hat{X}W, Ŷ) is a minimized 2-Wasserstein distance between the first embedding matrix (e.g., the source points) and the second embedding matrix (e.g., the target points), Pᵢⱼ is an updated permutation matrix (e.g., the permutation matrix), [symbol] is a set of permutation matrices (e.g., a plurality of permutation matrices), P is the permutation matrix, xᵢ is the subset of source points, yⱼ is the set of target points, W is an orthogonal matrix (e.g., the updated orthogonal matrix), ϵ is an entropy regularization term (e.g., ϵ=0.05), k is a total number of anchor points, i denotes a row of a matrix (e.g., an integer identifier of a row of a matrix), and j denotes a column of a matrix (e.g., an integer identifier of a column of a matrix).

In some non-limiting embodiments or aspects, the number of source points in the first subset of the plurality of source points may be greater than the number of clusters in the set of first clusters (e.g., m>k), and the number of target points in the second subset of the plurality of target points may be greater than the number of clusters in the set of second clusters (e.g., m>k). For example, the number of source points in the first subset of the plurality of source points may equal the number of clusters in the set of first clusters squared multiplied by a logarithm of the number of clusters in the first set of clusters (e.g., m=k² log k), and the number of target points in the second subset of the plurality of target points may equal the number of clusters in the set of second clusters squared multiplied by a logarithm of the number of clusters in the set of second clusters (e.g., m=k² log k). In some non-limiting embodiments or aspects, the number of source points in the first subset of the plurality of source points may equal the number of target points in the second subset of the plurality of target points.

In some non-limiting embodiments or aspects, the number of source points in the first subset of the plurality of source points may be equal to a target number of anchor points (e.g., the target number of anchor points is denoted by k) squared multiplied by a logarithm of the target number of anchor points (e.g., the number of clusters in the set of first clusters may be equal to the target number of anchor points and the number of clusters in the set of second clusters is equal to the target number of anchor points). In some non-limiting embodiments or aspects, the number of target points in the second subset of the plurality of target points may be equal to the target number of anchor points squared multiplied by a logarithm of the target number of anchor points.

In some non-limiting embodiments or aspects, the respective first anchor point for each respective first cluster of the set of first clusters may be a respective center point of the respective first cluster of the set of first clusters and the respective second anchor point for each respective second cluster of the set of second clusters may be a respective center point of the respective second cluster of the set of second clusters.

In some non-limiting embodiments or aspects, embedding alignment system 102 may cluster the first subset into the set of first clusters by clustering the first subset into the set of first clusters based on a k-means clustering algorithm. In some non-limiting embodiments or aspects, embedding alignment system 102 may cluster the second subset into the set of second clusters by clustering the second subset into the set of second clusters based on the k-means clustering algorithm. In some non-limiting embodiments or aspects, embedding alignment system 102 may cluster the first subset into the set of first clusters by clustering the first subset into the set of first clusters based on a k-means++ clustering algorithm. In some non-limiting embodiments or aspects, embedding alignment system 102 may cluster the second subset into the set of second clusters by clustering the second subset into the set of second clusters based on the k-means++ clustering algorithm.

As shown in FIG. 2, at step 212, process 200 may include updating the orthogonal matrix. For example, embedding alignment system 102 may update the orthogonal matrix based on at least one of a gradient descent and/or a Procrustes problem. In some non-limiting embodiments or aspects, embedding alignment system 102 may update the orthogonal matrix to generate an updated orthogonal matrix. For example, embedding alignment system 102 may update the orthogonal matrix to generate an updated orthogonal matrix based on a matrix approximation problem defined by equation (3) disclosed herein where W* is the updated orthogonal matrix, O_{d} is a set of orthogonal matrices (e.g., a plurality of orthogonal matrices), W is an original orthogonal matrix (e.g., the initial orthogonal matrix, a previously updated orthogonal matrix, and/or the like), X is the first embedding matrix, Y is the second embedding matrix, and ∥⋅∥_{F} denotes a Frobenius norm.

In some non-limiting embodiments or aspects, steps 210 and 212 (e.g., updating a permutation matrix and/or updating an orthogonal matrix) may be repeated for each step of a target number of steps (e.g., iterations). For example, steps 210 and 212 may be repeated for a target number of iterations for each epoch of a target number of epochs.

In some non-limiting embodiments or aspects, embedding alignment system may generate a machine learning model (e.g., a NLP machine learning model) based on training a machine learning algorithm using training data. In some non-limiting embodiments or aspects, embedding alignment system 102 may train a machine learning algorithm by inputting training data to the machine learning algorithm. In some non-limiting embodiments or aspects, the training data may include a plurality of pairs of corresponding source points and target points (e.g., one-to-one mappings of source points to target points) obtained from the updated permutation matrix including a quantized 2-Wasserstein distance for each pair of the plurality of pairs.

In some non-limiting embodiments or aspects, embedding alignment system 102 may analyze the plurality of pairs and/or the quantized 2-Wasserstein distance using a machine learning (ML) technique. For example, embedding alignment system 102 may analyze one or more pairs of corresponding source points and target points (e.g., one or more pairs of words and the quantized 2-Wasserstein distance associated with the pair of words, one or more pairs of source points and target points having one-to-one mappings obtained from the updated permutation matrix, etc.) using an ML technique. In some non-limiting embodiments, embedding alignment system 102 may analyze one or more pairs of source points and target points based on the updated permutation matrix using an NLP machine learning model. For example, embedding alignment system 102 may provide the one or more pairs of source points and target points (e.g., data associated with the one or more pairs of source points and target points, such as one-to-one mappings from the permutation matrix and/or quantized 2-Wasserstein distance between the source points or target points of the one or more pairs) for training the NLP machine learning model.

In some non-limiting embodiments or aspects, embedding alignment system 102 may provide a first word in a first language (e.g., “book” in English) as an input to a trained NLP machine learning model (e.g., a trained linear translation machine learning model) and receive an output from the trained NLP machine learning model based on the input. The output may include a translation of the first word in the first language to a second word in a second language (e.g., “nwoma” in Twi).

In some non-limiting embodiments, when analyzing the input using the trained NLP machine learning model, embedding alignment system 102 may classify the regulatory document using the NLP machine learning model and/or score (e.g., rate, rank, provide a confidence score, etc.) the regulatory document using the NLP machine learning model.

In some non-limiting embodiments, embedding alignment system 102 may process the first embedding matrix (e.g., the plurality of source points) and the second embedding matrix (e.g., the plurality of target points) to obtain training data for the NLP machine learning model. For example, embedding alignment system 102 may process the first embedding matrix and the second embedding matrix to generate a permutation matrix providing one-to-one mappings of source points to target points which may be used as training data to the machine learning algorithm to generate the NLP machine learning model. In some non-limiting embodiments, embedding alignment system 102 may process the first embedding matrix and the second embedding matrix to obtain the training data based on receiving the first embedding matrix and the second embedding matrix. Additionally or alternatively, embedding alignment system 102 may process the first embedding matrix and the second embedding matrix to obtain the training data based on embedding alignment system 102 receiving an indication that embedding alignment system 102 is to process the data from a user (e.g., a user of user device 310) of embedding alignment system 102, such as when embedding alignment system 102 receives an indication to create a NLP machine learning model for a time interval corresponding to the first embedding matrix and the second embedding matrix.

In some non-limiting embodiments, embedding alignment system 102 may analyze the training data to generate the NLP machine learning model. For example, embedding alignment system 102 may use machine learning techniques to analyze the training data to generate the NLP machine learning model. In some non-limiting embodiments, generating the NLP machine learning model (e.g., based on training data obtained from historical data) may be referred to as training the NLP machine learning model. The machine learning techniques may include, for example, supervised and/or unsupervised techniques, such as decision trees, logistic regressions, artificial neural networks, Bayesian statistics, learning automata, Hidden Markov Modeling, linear classifiers, quadratic classifiers, association rule learning, and/or the like. In some non-limiting embodiments, the machine learning techniques may include supervised techniques, such as artificial neural networks (e.g., convolution neural networks) and/or the like. In some non-limiting embodiments, the NLP machine learning model may include a model that is specific to a particular category of languages and/or the like.

In some non-limiting embodiments, embedding alignment system 102 may validate the NLP machine learning model. For example, embedding alignment system 102 may validate the NLP machine learning model after embedding alignment system 102 generates the NLP machine learning model. In some non-limiting embodiments, embedding alignment system 102 may validate the NLP machine learning model based on a portion of the training data to be used for validation. For example, embedding alignment system 102 may partition the training data into a first portion and a second portion, where the first portion may be used to generate the NLP machine learning model, as described above. In this example, the second portion of the training data (e.g., the validation data) may be used to validate the NLP machine learning model.

In some non-limiting embodiments, embedding alignment system 102 may validate the NLP machine learning model by providing validation data associated with one or more pairs of corresponding source points and target points (e.g., one or more pairs of words and the quantized 2-Wasserstein distance associated with the pair of words, one or more pairs of source points and target points having one-to-one mappings obtained from the updated permutation matrix, etc.) as input to the NLP machine learning model, and determining, based on an output of the NLP machine learning model, whether the NLP machine learning model correctly, or incorrectly, provided a linear translation of a first word in a first language to a second word in a second language. In some non-limiting embodiments, embedding alignment system 102 may validate the NLP machine learning model based on a validation threshold. For example, embedding alignment system 102 may be configured to validate the NLP machine learning model when a threshold value (e.g., the validation threshold) of translations from a first word to a second word are correctly predicted by the NLP machine learning model (e.g., when the NLP machine learning model correctly predicts 50% of the translations from a first word to a second word, 70% of the translations from a first word to a second word, a threshold number of the translations from a first word to a second word, and/or the like).

In some non-limiting embodiments, once the NLP machine learning model has been validated, embedding alignment system 102 may further train the NLP machine learning model and/or create new NLP machine learning models based on receiving new training data. The new training data may include additional data associated with one or more pairs of source points and target points from an updated (e.g., approximated) permutation matrix. In some non-limiting embodiments, embedding alignment system 102 may store the NLP machine learning model. For example, embedding alignment system 102 may store the NLP machine learning model in a data structure (e.g., a database, a linked list, a tree, and/or the like). The data structure may be located within embedding alignment system 102 or external, and possibly remote from, embedding alignment system 102. In one example, the data structure may be located in embedding data source 104.

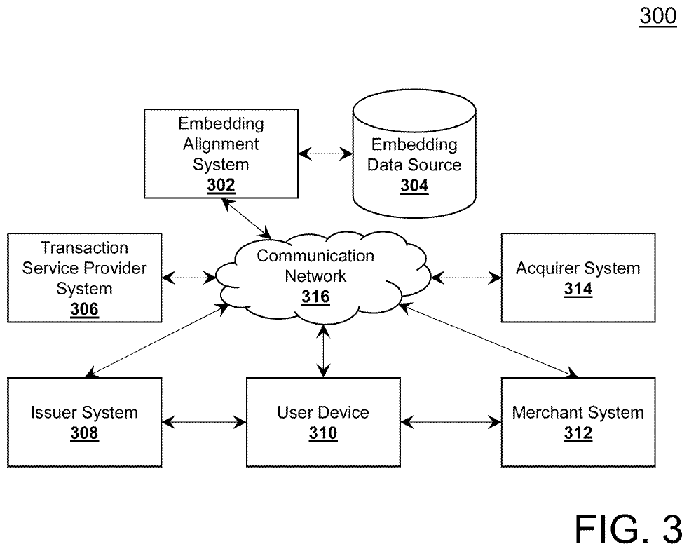

Referring now to FIG. 3, FIG. 3 is a diagram of a non-limiting embodiment or aspect of an exemplary environment 300 in which systems, products, and/or methods, as described herein, may be implemented. As shown in FIG. 3, environment 300 may include embedding alignment system 302, embedding data source 304, transaction service provider system 306, issuer system 308, user device 310, merchant system 312, acquirer system 314, and communication network 316. In some non-limiting embodiments or aspects, each of embedding alignment system 302 and/or embedding data source 304 may be implemented by (e.g., may be part of) another system, another device, another group of systems, or another group of devices, such as transaction service provider system 306. In some non-limiting embodiments or aspects, at least one of embedding alignment system 302 and/or embedding data source 304 may be implemented by (e.g., may be part of) another system, another device, another group of systems, or another group of devices, separate from or including transaction service provider system 306, such as issuer system 308, merchant system 312, acquirer system 314, and/or the like. In some non-limiting embodiments or aspects, embedding alignment system 302 may be the same as, or similar to, embedding alignment system 102. In some non-limiting embodiments or aspects, embedding data source 304 may be the same as, or similar to, embedding data source 104.

Embedding alignment system 302 may include one or more devices capable of receiving information from and/or communicating information to embedding data source 304. For example, embedding alignment system 302 may include a computing device, such as a computer, a server, a group of servers, and/or other like devices. In some non-limiting embodiments or aspects, embedding alignment system 102 may include at least one graphics processing unit (GPU), at least one central processing unit (CPU), and/or the like having highly parallel structure and/or multiple cores to enable more efficient and/or faster performance of calculating and/or aligning one or more embedding spaces. For example, embedding alignment system 102 may include one or more (e.g., a plurality of) GPUs.

In some non-limiting embodiments or aspects, embedding alignment system 302 may include one or more software instructions (e.g., one or more software applications) executing on a server (e.g., a single server), a group of servers, a computing device (e.g., a single computing device), a group of computing devices, and/or other like devices. In some non-limiting embodiments or aspects, embedding alignment system 302 may be configured to communicate with embedding data source 304. In some non-limiting embodiments or aspects, embedding alignment system 302 may be in communication with embedding data source 304 such that embedding alignment system 302 is separate from embedding data source 304. In some non-limiting embodiments or aspects, embedding data source 304 may be implemented by (e.g., may be part of) embedding alignment system 302.

Embedding data source 304 may include one or more devices capable of receiving information from and/or communicating information to embedding alignment system 302. For example, embedding data source 304 may include a computing device (e.g., a database device), such as a computer, a server, a group of servers, and/or other like devices. In some non-limiting embodiments or aspects, embedding data source 304 may be in communication with a data storage device, which may be local or remote to embedding data source 304. In some non-limiting embodiments or aspects, embedding data source 304 may be capable of receiving information from, storing information in, communicating information to, or searching information stored in the data storage device.

In some non-limiting embodiments or aspects, embedding data source 304 may be associated with one or more computing devices providing interfaces, such that a user (e.g., an administrative user) may interact with embedding data source 304 via the one or more computing devices. Embedding data source 304 may be in communication with embedding alignment system 302 such that embedding data source 304 is separate from embedding alignment system 302. Alternatively, in some non-limiting embodiments or aspects, embedding data source 304 may be implemented by (e.g., may be part of) embedding alignment system 302.

Transaction service provider system 306 may include one or more devices capable of receiving information from and/or communicating information to embedding alignment system 302, embedding data source 304, issuer system 308, user device 310, merchant system 312, and/or acquirer system 314 via communication network 316. For example, transaction service provider system 306 may include a computing device, such as a server (e.g., a transaction processing server), a group of servers, and/or other like devices. In some non-limiting embodiments or aspects, transaction service provider system 306 may be associated with a transaction service provider as described herein. In some non-limiting embodiments or aspects, transaction service provider system 306 may be in communication with a data storage device, which may be local or remote to transaction service provider system 306. In some non-limiting embodiments or aspects, transaction service provider system 306 may be capable of receiving information from, storing information in, communicating information to, or searching information stored in the data storage device. In some non-limiting embodiments, embedding alignment system 302 and/or embedding data source 304, may be part of transaction service provider system 306.

Issuer system 308 may include one or more devices capable of receiving information and/or communicating information to embedding alignment system 302, embedding data source 304, transaction service provider system 306, user device 310, merchant system 312, and/or acquirer system 314 via communication network 316. For example, issuer system 308 may include a computing device, such as a server, a group of servers, and/or other like devices. In some non-limiting embodiments or aspects, issuer system 308 may be associated with an issuer institution as described herein. For example, issuer system 308 may be associated with an issuer institution that issued a credit account, debit account, credit card, debit card, and/or the like to a user associated with user device 310.

User device 310 may include one or more devices capable of receiving information from and/or communicating information to embedding alignment system 302, embedding data source 304, transaction service provider system 306, issuer system 308, merchant system 312, and/or acquirer system 314 via communication network 316. Additionally or alternatively, each user device 310 may include a device capable of receiving information from and/or communicating information to other user devices 310 via communication network 316, another network (e.g., an ad hoc network, a local network, a private network, a virtual private network, and/or the like), and/or any other suitable communication technique. For example, user device 310 may include a client device and/or the like. In some non-limiting embodiments or aspects, user device 310 may or may not be capable of receiving information (e.g., from merchant system 312 or from another user device 310) via a short-range wireless communication connection (e.g., an NFC communication connection, an RFID communication connection, a Bluetooth® communication connection, a Zigbee® communication connection, and/or the like), and/or communicating information (e.g., to merchant system 312) via a short-range wireless communication connection.

Merchant system 312 may include one or more devices capable of receiving information from and/or communicating information to embedding alignment system 302, embedding data source 304, transaction service provider system 306, issuer system 308, user device 310, and/or acquirer system 314 via communication network 316. Merchant system 312 may also include a device capable of receiving information from user device 310 via communication network 316, a communication connection (e.g., an NFC communication connection, an RFID communication connection, a Bluetooth® communication connection, a Zigbee® communication connection, and/or the like) with user device 310, and/or the like, and/or communicating information to user device 310 via communication network 316, the communication connection, and/or the like. In some non-limiting embodiments or aspects, merchant system 312 may include a computing device, such as a server, a group of servers, a client device, a group of client devices, and/or other like devices. In some non-limiting embodiments or aspects, merchant system 312 may be associated with a merchant as described herein. In some non-limiting embodiments or aspects, merchant system 312 may include one or more client devices. For example, merchant system 312 may include a client device that allows a merchant to communicate information to transaction service provider system 306. In some non-limiting embodiments or aspects, merchant system 312 may include one or more devices, such as computers, computer systems, and/or peripheral devices capable of being used by a merchant to conduct a transaction with a user. For example, merchant system 312 may include a POS device and/or a POS system.

Acquirer system 314 may include one or more devices capable of receiving information from and/or communicating information to embedding alignment system 302, embedding data source 304, transaction service provider system 306, issuer system 308, user device 310, and/or merchant system 312 via communication network 316. For example, acquirer system 314 may include a computing device, a server, a group of servers, and/or the like. In some non-limiting embodiments or aspects, acquirer system 314 may be associated with an acquirer as described herein.

Communication network 316 may include one or more wired and/or wireless networks. For example, communication network 316 may include a cellular network (e.g., a long-term evolution (LTE) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

In some non-limiting embodiments or aspects, processing a transaction may include generating and/or communicating at least one transaction message (e.g., authorization request, authorization response, any combination thereof, and/or the like). For example, a client device (e.g., user device 310, a POS device of merchant system 312, and/or the like) may initiate the transaction, e.g., by generating an authorization request. Additionally or alternatively, the client device (e.g., user device 310, at least one device of merchant system 312, and/or the like) may communicate the authorization request. For example, user device 310 may communicate the authorization request to merchant system 312 and/or a payment gateway (e.g., a payment gateway of transaction service provider system 306, a third-party payment gateway separate from transaction service provider system 306, and/or the like). Additionally or alternatively, merchant system 312 (e.g., a POS device thereof) may communicate the authorization request to acquirer system 314 and/or a payment gateway. In some non-limiting embodiments or aspects, acquirer system 314 and/or a payment gateway may communicate the authorization request to transaction service provider system 306 and/or issuer system 308. Additionally or alternatively, transaction service provider system 306 may communicate the authorization request to issuer system 308. In some non-limiting embodiments or aspects, issuer system 308 may determine an authorization decision (e.g., authorize, decline, and/or the like) based on the authorization request. For example, the authorization request may cause issuer system 308 to determine the authorization decision based thereof. In some non-limiting embodiments or aspects, issuer system 308 may generate an authorization response based on the authorization decision. Additionally or alternatively, issuer system 308 may communicate the authorization response. For example, issuer system 308 may communicate the authorization response to transaction service provider system 306 and/or a payment gateway. Additionally or alternatively, transaction service provider system 306 and/or a payment gateway may communicate the authorization response to acquirer system 314, merchant system 312, and/or user device 310. Additionally or alternatively, acquirer system 314 may communicate the authorization response to merchant system 312 and/or a payment gateway. Additionally or alternatively, a payment gateway may communicate the authorization response to merchant system 312 and/or user device 310. Additionally or alternatively, merchant system 312 may communicate the authorization response to user device 310. In some non-limiting embodiments or aspects, merchant system 312 may receive (e.g., from acquirer system 314 and/or a payment gateway) the authorization response. Additionally or alternatively, merchant system 312 may complete the transaction based on the authorization response (e.g., provide, ship, and/or deliver goods and/or services associated with the transaction; fulfill an order associated with the transaction; any combination thereof; and/or the like).

For the purpose of illustration, processing a transaction may include generating a transaction message (e.g., authorization request and/or the like) based on an account identifier of a customer (e.g., associated with user device 310 and/or the like) and/or transaction data associated with the transaction. For example, merchant system 312 (e.g., a client device of merchant system 312, a POS device of merchant system 312, and/or the like) may initiate the transaction, e.g., by generating an authorization request (e.g., in response to receiving the account identifier from a portable financial device of the customer and/or the like). Additionally or alternatively, merchant system 312 may communicate the authorization request to acquirer system 314. Additionally or alternatively, acquirer system 314 may communicate the authorization request to transaction service provider system 306. Additionally or alternatively, transaction service provider system 306 may communicate the authorization request to issuer system 308. Issuer system 308 may determine an authorization decision (e.g., authorize, decline, and/or the like) based on the authorization request, and/or issuer system 308 may generate an authorization response based on the authorization decision and/or the authorization request. Additionally or alternatively, issuer system 308 may communicate the authorization response to transaction service provider system 306. Additionally or alternatively, transaction service provider system 306 may communicate the authorization response to acquirer system 314, which may communicate the authorization response to merchant system 312.

For the purpose of illustration, clearing and/or settlement of a transaction may include generating a message (e.g., clearing message, settlement message, and/or the like) based on an account identifier of a customer (e.g., associated with user device 310 and/or the like) and/or transaction data associated with the transaction. For example, merchant system 312 may generate at least one clearing message (e.g., a plurality of clearing messages, a batch of clearing messages, and/or the like). Additionally or alternatively, merchant system 312 may communicate the clearing message(s) to acquirer system 314. Additionally or alternatively, acquirer system 314 may communicate the clearing message(s) to transaction service provider system 306. Additionally or alternatively, transaction service provider system 306 may communicate the clearing message(s) to issuer system 308. Additionally or alternatively, issuer system 308 may generate at least one settlement message based on the clearing message(s). Additionally or alternatively, issuer system 308 may communicate the settlement message(s) and/or funds to transaction service provider system 306 (and/or a settlement bank system associated with transaction service provider system 306). Additionally or alternatively, transaction service provider system 306 (and/or the settlement bank system) may communicate the settlement message(s) and/or funds to acquirer system 314, which may communicate the settlement message(s) and/or funds to merchant system 312 (and/or an account associated with merchant system 312).

The number and arrangement of systems, devices, and/or networks shown in FIG. 3 are provided as an example. There may be additional systems, devices, and/or networks; fewer systems, devices, and/or networks; different systems, devices, and/or networks; and/or differently arranged systems, devices, and/or networks than those shown in FIG. 3. Furthermore, two or more systems or devices shown in FIG. 3 may be implemented within a single system or device, or a single system or device shown in FIG. 3 may be implemented as multiple, distributed systems or devices. Additionally or alternatively, a set of systems (e.g., one or more systems) or a set of devices (e.g., one or more devices) of environment 300 may perform one or more functions described as being performed by another set of systems or another set of devices of environment 300.

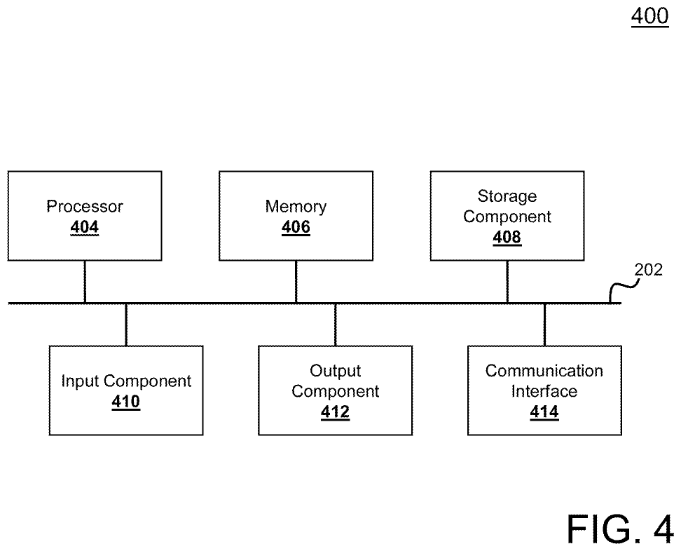

Referring now to FIG. 4, FIG. 4 is a diagram of example components of an exemplary device 400. Device 400 may correspond to one or more devices of the systems and/or devices shown in FIG. 1 or FIG. 3. In some non-limiting embodiments or aspects, each system and/or device shown in FIG. 1 or FIG. 3 may include at least one device 400 and/or at least one component of device 400. As shown in FIG. 4, device 400 may include bus 402, processor 404, memory 406, storage component 408, input component 410, output component 412, and communication interface 414.

Bus 402 may include a component that permits communication among the components of device 400. In some non-limiting embodiments or aspects, processor 404 may be implemented in hardware, firmware, or a combination of hardware and software. For example, processor 404 may include a processor (e.g., a central processing unit (CPU), a graphics processing unit (GPU), an accelerated processing unit (APU), and/or the like), a microprocessor, a digital signal processor (DSP), and/or any processing component (e.g., a field-programmable gate array (FPGA), an application-specific integrated circuit (ASIC), and/or the like), and/or the like, which can be programmed to perform a function. Memory 406 may include random access memory (RAM), read-only memory (ROM), and/or another type of dynamic or static storage device (e.g., flash memory, magnetic memory, optical memory, and/or the like) that stores information and/or instructions for use by processor 404. In some non-limiting embodiments or aspects, memory 406 may be the same as or similar to embedding data source 104.

Storage component 408 may store information and/or software related to the operation and use of device 400. For example, storage component 408 may include a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, and/or another type of computer-readable medium, along with a corresponding drive. In some non-limiting embodiments or aspects, storage component 408 may be the same as or similar to embedding data source 104.

Input component 410 may include a component that permits device 400 to receive information, such as via user input (e.g., a touch screen display, a keyboard, a keypad, a mouse, a button, a switch, a microphone, a camera, and/or the like). Additionally or alternatively, input component 410 may include a sensor for sensing information (e.g., a global positioning system (GPS) component, an accelerometer, a gyroscope, an actuator, and/or the like). Output component 412 may include a component that provides output information from device 400 (e.g., a display, a speaker, one or more light-emitting diodes (LEDs), and/or the like).

Communication interface 414 may include a transceiver-like component (e.g., a transceiver, a receiver and transmitter that are separate, and/or the like) that enables device 400 to communicate with other devices, such as via a wired connection, a wireless connection, or a combination of wired and wireless connections. Communication interface 414 may permit device 400 to receive information from another device and/or provide information to another device. For example, communication interface 414 may include an Ethernet interface, an optical interface, a coaxial interface, an infrared interface, a radio frequency (RF) interface, a universal serial bus (USB) interface, a Wi-Fi® interface, a Bluetooth® interface, a Zigbee® interface, a cellular network interface, and/or the like.

Device 400 may perform one or more processes described herein. Device 400 may perform these processes based on processor 404 executing software instructions stored by a computer-readable medium, such as memory 406 and/or storage component 408. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 406 and/or storage component 408 from another computer-readable medium or from another device via communication interface 414. When executed, software instructions stored in memory 406 and/or storage component 408 may cause processor 404 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

The number and arrangement of components shown in FIG. 4 are provided as an example. In some non-limiting embodiments or aspects, device 400 may include additional components, fewer components, different components, or differently arranged components than those shown in FIG. 4. Additionally or alternatively, a set of components (e.g., one or more components) of device 400 may perform one or more functions described as being performed by another set of components of device 400.

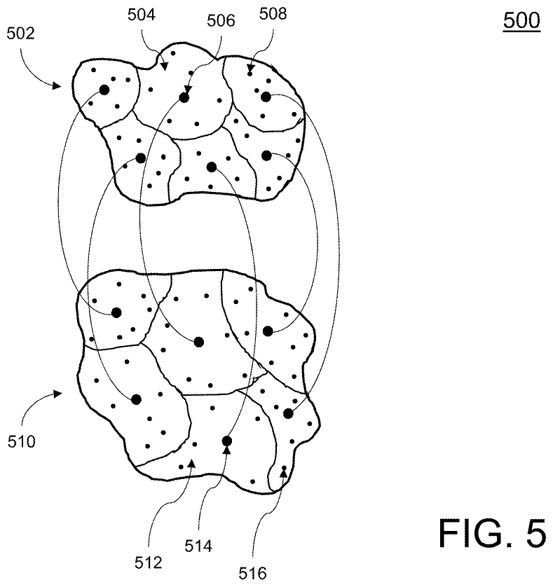

Referring now to FIG. 5, FIG. 5 is a diagram of a non-limiting embodiment or aspect of an output 500 generated by a processor programmed or configured to perform methods for unsupervised alignment of embedding spaces. Output 500 may include set of first clusters 502, first cluster 504 of set of first clusters 502, first anchor point 506 of first cluster 504, source point 508 of a subset of source points (e.g., of the plurality of source points), set of second clusters 510, second cluster 512 of set of second clusters 510, second anchor point 514 of second cluster 512, and target point 516 of a subset of target points (e.g., of the plurality of target points).

In some non-limiting embodiments or aspects, set of first clusters 502 may include a plurality of clusters determined by embedding alignment system 102. In some non-limiting embodiments or aspects, a number of clusters in the plurality of clusters of set of first clusters 502 may be equal to a predetermined number (e.g., a predetermined number of anchor points, such as k). In some non-limiting embodiments or aspects, set of first clusters 502 may be associated with a set of second clusters (e.g., set of second clusters 510). In some non-limiting embodiments or aspects, embedding alignment system 102 may determine set of first clusters 502 based on the plurality of source points of the first embedding matrix.

In some non-limiting embodiments or aspects, first cluster 504 may include a cluster (e.g., a respective cluster) of set of first clusters 502. In some non-limiting embodiments or aspects, first cluster 504 may include at least one first anchor point 506 and one or more source points 508 (e.g., a subset of source points of the plurality of source points). In some non-limiting embodiments or aspects, embedding alignment system 102 may determine first cluster 504 based on a k-means clustering algorithm (e.g., k-means++). In some non-limiting embodiments or aspects, first cluster 504 may be associated with at least one second cluster (e.g., second cluster 512 or another second cluster of set of second clusters 510).

In some non-limiting embodiments or aspects, first anchor point 506 may include an anchor point of a cluster, such as first cluster 504 (e.g., a respective first anchor point of a cluster of set of first clusters 502). In some non-limiting embodiments or aspects, first anchor point 506 may include a centroid (e.g., a center point determined based on surrounding points) of a cluster (e.g., first cluster 504). In some non-limiting embodiments or aspects, first anchor point 506 may be associated with a second anchor point (e.g., second anchor point 514 or another second anchor point of a second cluster of set of second clusters 510). In some non-limiting embodiments or aspects, a quantized 2-Wasserstein distance may refer to a distance between first anchor point 506 and the second anchor point with which first anchor point 506 is associated.

In some non-limiting embodiments or aspects, source point 508 of a subset of source points (e.g., of the plurality of source points) may include a point that is included in (e.g., represented in) the first embedding matrix. In some non-limiting embodiments or aspects, source point 508 may be represented as a vector in a coordinate space (e.g., a 2-dimensional coordinate space, a 3-dimensional coordinate space, and/or the like). In some non-limiting embodiments or aspects, source point 508 may represent a cross-lingual word embedding (e.g., an embedding representation of a word) in a language (e.g., English, Italian, Russian, Twi, and/or the like). For example, source point 508 may be associated with target point 516 based on a relationship between source point 508 and target point 516 where source point 508 may represent a word in a first language (e.g., English) and target point 516 may represent a translation of the word in a second language (e.g., Twi). In this way, embedding alignment system 102 may determine an alignment (e.g., the quantized 2-Wasserstein distance) between first anchor points and second anchor points to learn translations of words between the first language and the second language.

In some non-limiting embodiments or aspects, set of second clusters 510 may include a plurality of clusters determined by embedding alignment system 102. In some non-limiting embodiments or aspects, a number of clusters in the plurality of clusters of set of second clusters 510 may be equal to a predetermined number (e.g., a predetermined number of anchor points, such as k). In some non-limiting embodiments or aspects, set of second clusters 510 may be associated with a set of first clusters (e.g., set of first clusters 502). In some non-limiting embodiments or aspects, embedding alignment system 102 may determine set of second clusters 510 based on the plurality of target points of the second embedding matrix.

In some non-limiting embodiments or aspects, second cluster 512 may include a cluster (e.g., a respective cluster) of set of second clusters 510. In some non-limiting embodiments or aspects, second cluster 512 may include at least one second anchor point 514 and one or more target points 516 (e.g., a subset of target points of the plurality of target points). In some non-limiting embodiments or aspects, embedding alignment system 102 may determine second cluster 512 based on a k-means clustering algorithm (e.g., k-means++). In some non-limiting embodiments or aspects, second cluster 512 may be associated with at least one first cluster (e.g., first cluster 504 or another first cluster of set of first clusters 502).

In some non-limiting embodiments or aspects, second anchor point 514 may include an anchor point of a cluster, such as second cluster 512 (e.g., a respective first anchor point of a cluster of set of second clusters 510). In some non-limiting embodiments or aspects, second anchor point 514 may include a centroid (e.g., a center point determined based on surrounding points) of a cluster (e.g., second cluster 512). In some non-limiting embodiments or aspects, second anchor point 514 may be associated with a first anchor point (e.g., first anchor point 506 or another first anchor point of a first cluster of set of first clusters 502). In some non-limiting embodiments or aspects, a quantized 2-Wasserstein distance may refer to a distance between second anchor point 514 and the first anchor point with which second anchor point 514 is associated.

In some non-limiting embodiments or aspects, target point 516 of a subset of target points (e.g., of the plurality of target points) may include a point that is included in (e.g., represented in) the second embedding matrix. In some non-limiting embodiments or aspects, target point 516 may be represented as a vector in a coordinate space (e.g., a 2-dimensional coordinate space, a 3-dimensional coordinate space, and/or the like). In some non-limiting embodiments or aspects, target point 516 may represent a cross-lingual word embedding (e.g., an embedding representation of a word) in a language (e.g., English, Italian, Russian, Twi, and/or the like). For example, target point 516 may be associated with source point 508 based on a relationship between target point 516 and source point 508 where target point 516 may represent a word in a second language (e.g., Twi) and source point 508 may represent a translation of the word in a first language (e.g., English). In this way, embedding alignment system 102 may determine the alignment (e.g., the quantized 2-Wasserstein distance) between first anchor points and second anchor points to learn translations of words between the first language and the second language.

Thus, embedding alignment system 102 may determine a first alignment (e.g., based on the permutation matrix and/or the updated permutation matrix) between the first anchor points and the second anchor points. Embedding alignment system 102 may then determine a second alignment between each source point and each target point based on the first alignment by approximating the second alignment (e.g., based on the permutation matrix and/or the updated permutation matrix), thus minimizing the required inputs and reducing the number of resources required to determine and/or learn distances between points and/or translations of words between the first language and the second language.

Although the disclosed subject matter has been described in detail for the purpose of illustration based on what is currently considered to be the most practical and preferred embodiments or aspects, it is to be understood that such detail is solely for that purpose and that the disclosed subject matter is not limited to the disclosed embodiments or aspects, but, on the contrary, is intended to cover modifications and equivalent arrangements that are within the spirit and scope of the appended claims. For example, it is to be understood that the presently disclosed subject matter contemplates that, to the extent possible, one or more features of any embodiment or aspect can be combined with one or more features of any other embodiment or aspect.

1. A computer-implemented method, comprising:
receiving, with at least one processor, a first embedding matrix and a second embedding matrix, wherein the first embedding matrix comprises a plurality of source points and the second embedding matrix comprises a plurality of target points;
initializing, with the at least one processor, an initial permutation matrix and an initial orthogonal matrix;
determining, with the at least one processor, a permutation matrix based on the initial permutation matrix, the first embedding matrix, and the second embedding matrix;
determining, with the at least one processor, an orthogonal matrix based on the initial orthogonal matrix, the first embedding matrix, the permutation matrix, and the second embedding matrix; and
for each step of a target number of steps:
updating, with the at least one processor, the permutation matrix based on a quantized 2-Wasserstein distance; and
updating, with the at least one processor, the orthogonal matrix based on a gradient descent and a Procrustes problem.

2. The method of claim 1, wherein determining the permutation matrix comprises determining the permutation matrix based on a Frank-Wolfe algorithm.

3. The method of claim 1, wherein determining the orthogonal matrix comprises determining the orthogonal matrix based on a Procrustes problem.

4. The method of claim 1, wherein the target number of steps comprises a target number of iterations for each epoch of a target number of epochs.

5. The method of claim 1, wherein updating the permutation matrix comprises:
sampling a first subset of the plurality of source points;
sampling a second subset of the plurality of target points;
clustering the first subset into a set of first clusters;
clustering the second subset into a set of second clusters;
determining a respective first anchor point for each first cluster of the set of first clusters;
determining a respective second anchor point for each second cluster of the set of second clusters;
determining a set of first weight values based on each respective source point of each respective first cluster and the respective first anchor point;
determining a set of second weight values based on each respective target point of each respective second cluster and the respective second anchor point; and
updating the permutation matrix based on the set of first weight values and the set of second weight values.

6. The method of claim 5, wherein updating the permutation matrix further comprises:
determining a cost matrix based on the respective first anchor point of each first cluster and the respective second anchor point of each second cluster,
wherein updating the permutation matrix based on the set of first weight values and the set of second weight values comprises updating the permutation matrix based on the set of first weight values, the set of second weight values, and the cost matrix.

7. The method of claim 5, wherein updating the permutation matrix based on the set of first weight values and the set of second weight values comprises:
determining a weighted Wasserstein distance based on the set of first weight values and the set of second weight values; and
updating the permutation matrix based on the weighted Wasserstein distance.

8. The method of claim 7, wherein determining the weighted Wasserstein distance comprises determining the weighted Wasserstein distance based on a Sinkhorn approximate solver.

9. The method of claim 5, wherein a number of source points in the first subset of the plurality of source points is greater than a first number of clusters in the set of first clusters, and wherein a number of target points in the second subset of the plurality of target points is greater than a second number of clusters in the set of second clusters.

10. The method of claim 9, wherein:
the number of source points in the first subset of the plurality of source points is equal to a target number of anchor points squared multiplied by a logarithm of the target number of anchor points, and
the number of target points in the second subset of the plurality of target points is equal to the target number of anchor points squared multiplied by a logarithm of the target number of anchor points.

11. The method of claim 5, wherein the respective first anchor point for each respective first cluster of the set of first clusters is a respective center point of the respective first cluster of the set of first clusters.

12. The method of claim 5, wherein the respective second anchor point for each respective second cluster of the set of second clusters is a respective center point of the respective second cluster of the set of second clusters.

13. The method of claim 5, wherein clustering the first subset into the set of first clusters comprises clustering, with at least one processor, the first subset into the set of first clusters based on a k-means clustering algorithm, and wherein clustering the second subset into the set of second clusters comprises clustering, with at least one processor, the second subset into the set of second clusters based on the k-means clustering algorithm.

14. The method of claim 5, wherein clustering the first subset into the set of first clusters comprises clustering the first subset into the set of first clusters based on a k-means++ clustering algorithm, and wherein clustering the second subset into the set of second clusters comprises clustering, with at least one processor, the second subset into the set of second clusters based on the k-means++ clustering algorithm.

15. A system comprising at least one processor programmed or configured to:
receive a first embedding matrix and a second embedding matrix, wherein the first embedding matrix comprises a plurality of source points and the second embedding matrix comprises a plurality of target points;
initialize an initial permutation matrix and an initial orthogonal matrix;
determine a permutation matrix based on the initial permutation matrix, the first embedding matrix, and the second embedding matrix;
determine an orthogonal matrix based on the initial orthogonal matrix, the first embedding matrix, the permutation matrix, and the second embedding matrix; and
for each step of a target number of steps, the at least one processor is programmed or configured to:
update the permutation matrix based on a quantized 2-Wasserstein distance; and
update the orthogonal matrix based on a gradient descent and a Procrustes problem.

16. The system of claim 15, wherein, when determining the permutation matrix, the at least one processor is programmed or configured to determine the permutation matrix based on a Frank-Wolfe algorithm.

17. The system of claim 15, wherein, when determining the orthogonal matrix, the at least one processor is programmed or configured to determine the orthogonal matrix based on a Procrustes problem.

18. The system of claim 15, wherein the target number of steps comprises a target number of iterations for each epoch of a target number of epochs.

19. The system of claim 15, wherein, when updating the permutation matrix, the at least one processor is programmed or configured to:
sample a first subset of the plurality of source points;
sample a second subset of the plurality of target points;
cluster the first subset into a set of first clusters;
cluster the second subset into a set of second clusters;
determine a respective first anchor point for each first cluster of the set of first clusters;
determine a respective second anchor point for each second cluster of the set of second clusters;
determine a set of first weight values based on each respective source point of each respective first cluster and the respective first anchor point;
determine a set of second weight values based on each respective target point of each respective second cluster and the respective second anchor point; and
update the permutation matrix based on the set of first weight values and the set of second weight values.

20-28. (canceled)

29. A computer program product comprising at least one non-transitory computer-readable medium including one or more instructions that, when executed by at least one processor, cause the at least one processor to:
receive a first embedding matrix and a second embedding matrix, wherein the first embedding matrix comprises a plurality of source points and the second embedding matrix comprises a plurality of target points;
initialize an initial permutation matrix and an initial orthogonal matrix;
determine a permutation matrix based on the initial permutation matrix, the first embedding matrix, and the second embedding matrix;
determine an orthogonal matrix based on the initial orthogonal matrix, the first embedding matrix, the permutation matrix, and the second embedding matrix; and
for each step of a target number of steps, the one or more instructions cause the at least one processor to:
update the permutation matrix based on a quantized 2-Wasserstein distance; and
update the orthogonal matrix based on a gradient descent and a Procrustes problem.

30-42. (canceled)
